(19) United States
(12) Patent Application Publication
(10) Pub. No.: US 2011/0152021 A1
(43) Pub. Date: Jun. 23, 2011

(54) QUICK RELEASE MECHANISM FOR TELESCOPIC CONVEYOR

(75) Inventors: Thorkil J. JOHANNSEN, Norval (CA); Alex Lecker, Richmond Hill (CA)

(73) Assignee: Thor Global Enterprises Ltd., Ontario (CA)

(21) Appl. No.: 12/946,558

(22) Filed: Nov. 15, 2010

(30) Foreign Application Priority Data
Dec. 21, 2009 (CA) 2688940

(51) Int. Cl. F16H 7/08

(52) U.S. Cl. 474/110; 474/101

(57) ABSTRACT

Disclosed is a release mechanism suitable for releasing and disengaging a chain drive means associated with a drive mechanism for a movable extendable frame assembly. In the arrangement, the drive mechanism includes a drive, a wheel assembly and a drive chain associated with the drive to drive wheels associated with the frame assembly. The mechanism also includes a quick release for permitting the chain drive to be released and disengaged from driving the wheels. The quick release has a movable support mounting the drive, and in which the support is movable about a fixed point to raise and lower the drive from a lower chain tensioned position to an upper chain release position.

### PRIORITY

This application claims priority under 35 U.S.C. § 119 to an application filed in the Canadian Intellectual Property Office on Dec. 21, 2009, and assigned Patent Application No. 2,688,940, the contents of which is incorporated herein by reference.

### FIELD OF THE INVENTION

The present invention relates to a quick release mechanism for the working or positional wheel assemblies of a mobile telescopic conveyor apparatus.

### BACKGROUND OF THE INVENTION

Mobile telescopic conveyor systems are used to transport materials from one location to another location. A telescopic conveyor system or apparatus includes a telescopic frame system including a base frame with an elongated extendible frame which is mounted for reciprocal movement with respect to the base frame. The elongated extendible frame is moveable from a retracted position within the base frame to an extended position extending outwardly from the base frame. Both the base frame and the extendible frame include a conveyor belt which forms a load bearing surface which serves to move a load from a feed end of the conveyor system (which is located at a lower end of the base frame) to a discharge end of the conveyor system which is located at an upper end of the extendible frame.

Canadian Patent 2,223,202 discloses such a known mobile telescopic conveyor system which is suitable for use in heavy industries such as the aggregate industry where mobile conveyors are used to construct non-segregated stock piles of aggregate materials.

The telescopic frame system is typically provided with a support frame including wheel assemblies to enable transportation of the telescopic conveyor system and as well to enable the position of the telescopic conveyor system to be changed when in a fully extended working or use position. Typically the system includes a first wheel assembly primarily for road transportation of the system and a further wheel assembly for pivoting or moving the position of the extendible frame portion radially when in use. The wheel assembly for changing the position of the extendible frame can be moved from a use or working position where the position of the extendible frame can be radially moved from one position to another to a transport position. In the use or working position the wheel assemblies extend substantially transversely from the longitudinal axis of the telescopic frame system and allow the conveyor belt/frame system to be radially rotated about the feed end. When in the use or working position the wheel assembly is connected to a drive motor by way of a chain to permit the driving/movement of the wheel assembly. In the transport position, the wheel assembly extends parallel to the longitudinal axis of the telescopic frame system and permits the conveyor belt system to be towed from place to place with the extendible frame in a fully lowered and retracted position. When in a transport position, the chain is disengaged from the wheel assembly/drive motor to permit free rotation of the wheels.

As noted above, the conversion from the use or working position to the transport position involves the removal of the drive chain from the wheel assembly/drive motor. Such removal of the chain is a somewhat time consuming operation as it requires an operator to utilize tools to manually remove a bolt or other chain connecting means from the drive chain to break or open the chain at which point it can be manually removed.

### SUMMARY OF THE INVENTION

In accordance with an embodiment of the present invention, there is provided the improvement which relates to a release mechanism suitable for releasing and disengaging a chain drive means associated with a drive mechanism for a movable extendable frame assembly; the improvement is directed to a drive mechanism comprising a drive means, a wheel assembly and a drive chain associated with said drive means to drive wheels associated with said frame assembly, together with the improvement comprising a quick release means for permitting the chain drive to be released and disengaged from driving said wheels, said quick release means having a movable support mounting said drive means, said support being movable about a fixed point to raise and lower said drive means from a lower chain tensioned position to an upper chain release position.

Desirably, in the above embodiment, the support is in the form of a support plate; further, desirably the movement of said support is actuated by a lever.

In further preferred embodiments, a lock member is provided for releasably locking the support plate in a lower chain tensioned position.

In accordance with another embodiment of the present invention, there is provided a drive mechanism for a wheel assembly of a telescopic mobile conveyor apparatus. The drive mechanism includes a drive support member mounted on the conveyor apparatus. A drive motor is mounted on the drive support member. The drive motor includes a first sprocket member. A second sprocket member is associated with the wheel assembly. A drive chain is mounted on the first and second sprockets and extends between the drive motor and the wheel assembly. The support member is rotatably mounted for movement between a first position and a second position. In the first position of the support member a distance between said first and second sprockets is sufficient to provide tension to the chain member. In the second position, the distance between the first and second sprockets is reduced to reduce the tension on the chain member and permit its removal.

Preferably, an actuator is provided for movement of the support member from the first position to the second position. The actuator may be in the form of a mechanical actuator, pneumatic actuator, hydraulic actuator, electric actuator or any combination thereof.

A locking mechanism may also be provided for releasably locking the support member in the first or second positions.

### BRIEF DESCRIPTION OF THE DRAWINGS

FIG. 1 is a perspective view of a mobile conveyor system in a retracted road transport condition on a transport vehicle;

FIG. 2 is a perspective view of the working wheel assembly with the quick release mechanism of the present invention;

FIG. 3 is a side elevational view of the quick release mechanism of the present invention, with the chain engaged for driving the working wheel assembly; and

FIG. 4 is a side elevational view of the quick release mechanism of the present invention, with the quick release mechanism in a chain release position for disengaging the chain from the working wheel assembly.

### DETAILED DESCRIPTION

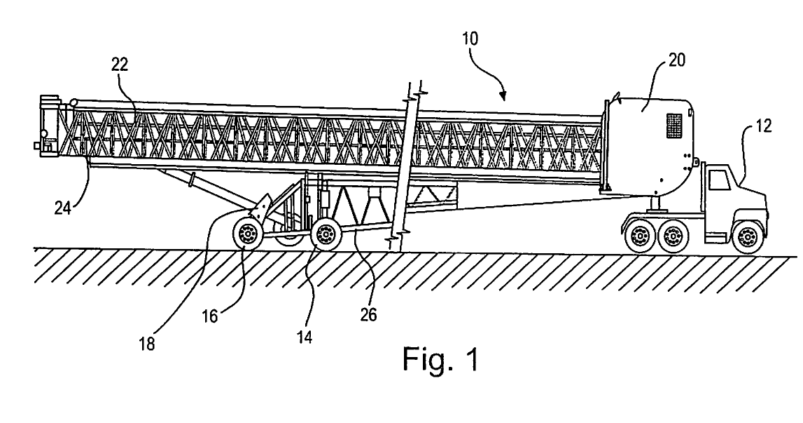

Reference is initially made to FIG. 1 which illustrates a mobile telescopic conveyor system 10 in a transport position attached to a transport vehicle 12. The telescopic frames 22, 24 of the conveyor system 10 are in the fully lowered and retracted transport position. The conveyor system 10 is provided with a support frame 26 which includes a transport wheel assembly 14 and a working wheel assembly 16 for positional rotation of the telescopic frames 22, 24 about a feed end 20 when extended in a use or working position. The working wheel assembly 16 is driven by a drive motor (not shown) and chain assembly (not shown). A guard member 18 is provided to guard the chain mechanism.

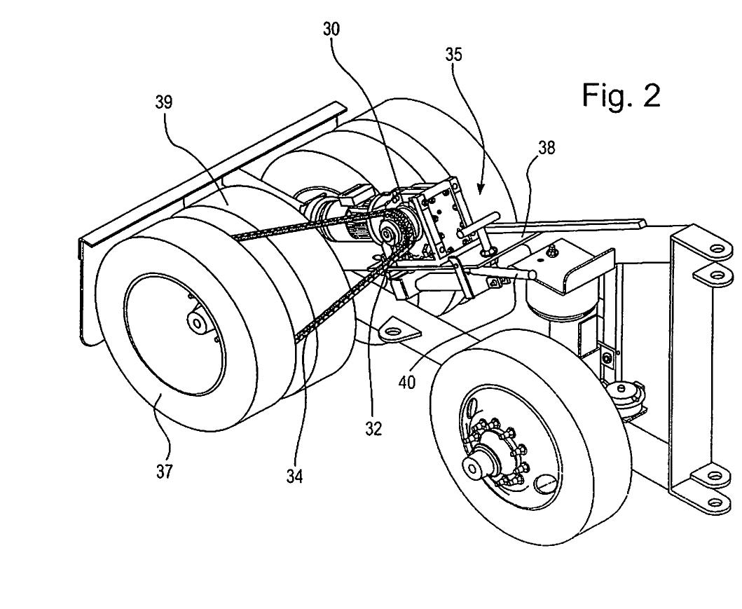

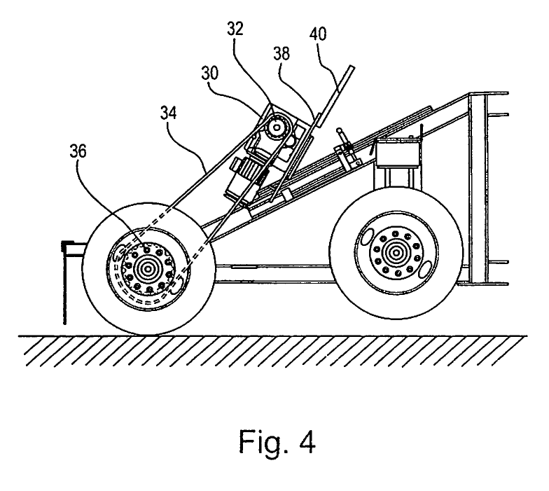

Reference will now be made to FIGS. 2, 3 and 4 which illustrate the working wheel assembly 16, the drive motor 30 and the quick release means of the present invention, designated generally by reference numeral 35. The drive motor 30 includes a sprocket 32 for mounting the chain 34. The working wheel assembly 16 includes a cooperating sprocket 36.

The chain 34 is tensioned between the sprocket 32 of the drive motor 30 and the sprocket 36 of the working wheel assembly 16, to permit driving of the wheels 37, 39 for radial adjustment of the position of the telescopic conveyor system 10 when in a fully extended use position. When in a use or working position, the working wheel assembly 16 is rotated to extend substantially transversely from the longitudinal axis of the telescopic frame 10 and allows the telescopic frame 10 to be radially rotated about the feed end 20. When in the transport position, the working wheel assembly 16 extends parallel to the longitudinal axis of the telescopic frame 10 to permit the mobile conveyor system to be towed from one location to another.

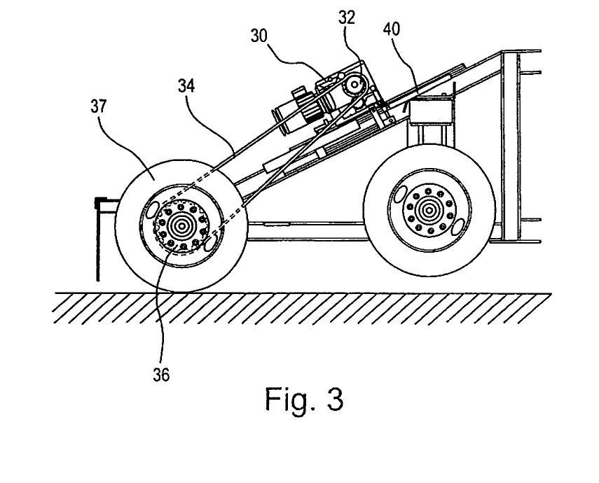

The drive motor 30 is mounted on a support member 38 which is pivotally mounted to the support frame 26. The support member 38 is pivotable from a locked position shown in FIG. 3 where the chain 34 is maintained in a tensioned position to enable the driving of the working wheel assembly 16 to adjust the position of the telescopic conveyor frame 10, when in use, to a position where the tension is removed from the chain 34 and the chain 34 can be easily removed by disengagement from the sprockets 32 and 36. The pivoting movement of the support member 38 is carried out by lifting the lever 40 in an upward position; this change in position of the support member 38 serves to relieve the tension of the chain 34. Once the tension has been removed from the chain 34, the chain 34 can be easily removed from the wheel assembly 16 and drive motor 30 and the wheel assembly positioned in a road transport condition.

A locking mechanism can be provided for releasably retaining the support member 38 in the lower chain tensioned position.

Although specific embodiments have been described and illustrated, it will be appreciated that a variety of alternate or equivalent implementations may be substituted for the specific embodiments shown without departing from the spirit and scope of the invention

1. In a release mechanism suitable for releasing and disengaging a chain drive means associated with a drive mechanism for a movable extendable frame assembly, wherein the drive mechanism comprises a drive means, a wheel assembly and a drive chain associated with said drive means and said wheel assembly to drive wheels associated with said wheel assembly, the improvement comprising:
quick release means for permitting the drive chain to be released and disengaged from driving said wheels, said quick release means having a movable support mounting said drive means, said support being movable about a fixed point to raise and lower said drive means from a lower chain tensioned position to an upper chain release position.

2. The release mechanism of claim 1, wherein said support is in the form of a support plate.

3. The release mechanism of claim 1, wherein the movement of said support is actuated by a lever.

4. The release mechanism of claim 1, further comprising a locking means for locking said support in a lower chain tensioned position.

5. A drive mechanism for a wheel assembly of a telescopic mobile conveyor apparatus comprising:
a drive support member mounted on said conveyor apparatus;
a drive motor mounted on said drive support member, said drive motor including a first sprocket;
a second sprocket associated with said wheel assembly;
a drive chain mounted on said first and second sprockets and extending between the drive motor and the wheel assembly;
wherein said support member is rotatably mounted for movement between a first position and a second position, said first position of the support member providing for a distance between said first and second sprockets which provides tension to the chain and the second position where the distance between the first and second sprockets is reduced to reduce the tension on the chain member and permit its removal.

6. The drive mechanism of claim 5, further comprising actuator means for movement of said support member from said first and second positions.

7. The drive mechanism of claim 6, wherein said actuator means is a mechanical actuator.

8. The drive mechanism of claim 6, wherein said actuator means is selected from the group consisting of hydraulic, pneumatic, and electric actuating means.

9. The drive mechanism of claim 7, wherein the actuator means is a lever.

10. The drive mechanism of claim 5, further comprising a locking means for releasably locking said support member in the first position.
